(19) United States
(12) Patent Application Publication
(10) Pub. No.: US 2010/0305965 A1
(43) Pub. Date: Dec. 2, 2010

(54) INTEGRATED REPORT GENERATION OF MEDICAL DATA WITH VARYING LEVELS OF INFORMATION

(75) Inventors: Drinda BENJAMIN, Oakland, CA (US); Charles WEI, Fremont, CA (US); Jai KARAN, Fremont, CA (US); Gary A. HAYTER, Oakland, CA (US)

Correspondence Address: Fulwider Patton LLP (ADC), 6060 Center Drive, 10th Floor, Los Angeles, CA, 90045, US

(73) Assignee: ABBOTT DIABETES CARE INC., Alameda, CA (US)

(21) Appl. No.: 12/790,058

(22) Filed: May 28, 2010

Related U.S. Application Data
(60) Provisional application No. 61/182,611, filed on May 29, 2009.

(51) Int. Cl. G06Q 50/00; G06F 3/048

(52) U.S. Cl. 705/2; 715/808; 715/856

(57) ABSTRACT

A system for generating a report having varying integrated levels of medical information related to a health condition is provided. The system comprises a host server having a host database and a client component that connects to the host server. The client component includes a report software application that is configured to generate a report and provide a GUI on the display. A processor populates the GUI based upon received and processed medical information from the host server component and arranges the medical information in predetermined, inter-related levels. A cursor is provided to allow the user to point to an area of interest in the display and a further level of information pertaining to one or more layers of medical information is viewable by a user when the cursor is pointed over an image on the display.

### CROSS-REFERENCE TO RELATED APPLICATION

This application is claiming the benefit of a co-pending provisional application Ser. No. 61/182,611 filed on May 29, 2009.

### BACKGROUND OF THE INVENTION

1. Field of the Invention

The present disclosure relates to methods and systems for generating integrated analyses and reports of medical information while relaying varying levels of detail.

2. Description of the Related Art

Medical devices can generate information that, through use of various calculation or reporting features assist in evaluating medical data and assist in the management of a monitored health condition. For example, insulin pumps may incorporate a calculator or otherwise be adapted to respond to measurements and, calculations based thereon for adjustment of an insulin dosage or to provide recommendations for better blood glucose management in a patient with diabetes. Conveniently, a integrated report can be used to display such measurements and calculations together with, or to aid in developing, health management recommendations.

For chronic conditions such as diabetes, however, the volume of data obtainable regarding a patient's condition (e.g., blood glucose levels) over a period of time may be greater than the amount of information that can be readily understood by the patient or utilized by a healthcare provider on a single screen display. This is especially true where more than one variable affecting the patient's condition is being monitored (e.g., the course of drug therapy and patient behaviors, such as food intake). Further, where both the patient and the clinician have access to the same kind of data, the former may have considerably less understanding of its import than the latter.

Hence those skilled in the art have recognized a need for a simple to use system that allows the user to choose when and whether to access more than one level of information relating to a medically relevant data point. Such a system could provide instant and accurate access to medical information and would therefore contribute significantly to better management of the medical condition.

### SUMMARY OF THE INVENTION

One embodiment of the invention is directed to a system for generating a report having varying integrated levels of medical information related to a health condition available to a user. The system comprises a host server component that connects to and controls access to a host database. The host server component is accessible by multiple users, and the host server component receives and stores medical information in the host database.

A client component is configured to connect to the host server component via a communication link. The client component comprises a display, a communication port, an input device, a processor, and a memory. A report software application is stored on the memory in combination with a GUI rendering component and is configured to generate a report. The processor is configured to access the memory, load and run the report software application under which the processor is programmed to, in combination with the graphical interface rendering component, provide a GUI on the display. The processor populates the GUI based upon received and processed medical information from the host server component and arranges the medical information in predetermined, inter-related levels such that the levels of information are accessible by the user on the GUI. A cursor is provided to allow the user to point to an area of interest in the display and a non-tabular visual information element is provided and disposed in the display, where the non-tabular visual information element represents a level of medical information. A further level of information pertaining to one or more layers of medical information is viewable by a user when the cursor is pointed over an image on the display.

In another embodiment, a report generation system for managing medical information related to a health condition is provided. The system comprises a host server component connected to and controlling access to a host database. The host server component is accessible by multiple users and stores multiple patient data sets, wherein the multiple patient data sets include medical information received from respective users, and the host server component is configured to receive and transmit user data.

A client component is configured to connect to the host server component via a communication link. The client component comprises a client database, a display, a processor, a memory and a report software application stored on the memory. The report software application is configured to generate reports. The processor is configured to access the memory, load and run the report software management program under which the processor is programmed to receive medical information from at least one of the client database and host database, process the received medical information, and provide a GUI on the display that allows for user-interaction related to components displayed on the GUI. The process further populates the GUI based upon received medical information and arranges the medical information in predetermined, inter-related levels such that the levels of information are accessible by the user on the GUI. A cursor is provided for pointing to an area of interest in the display. Also, a non-tabular visual information element is provided and is disposed in the display, wherein the non-tabular visual information element represents a level of medical information. A further level of information pertaining to one or more layers of medical information are simultaneously viewable by a user when the cursor is pointed over an image on the display.

Another embodiment is directed to a system comprising a client component connected to a medical device. The client component includes a processor, a memory, and a display. A report software application is stored on the memory. The processor loads and runs the software application and is programmed to receive medical information directly from the connected medical device. The received medical information is processed and then is used to populated the GUI in the display. Optionally, the client component may also comprise a client database for storing received medical information.

### BRIEF DESCRIPTION OF THE DRAWINGS

The accompanying drawings, which constitute a part of this specification, illustrate various implementations and aspects of the present invention and, together with the description, explain the principles of the invention. In the drawings:

FIG. 1 illustrates a block diagram of an integrated analysis and report generation system providing varying levels of information, according to an embodiment wherein a host server component is provided;

FIGS. 2-5 display features of an integrated reporting system provided on a GUI, according to embodiments;

FIG. 6 displays examples of GUI components that may be populated on a GUI, according to embodiments; and

FIG. 7 displays examples of GUI components that may be populated on a GUI, according to embodiments.

### DETAILED DESCRIPTION OF PREFERRED EMBODIMENTS

Reference will now be made in detail to embodiments in the accompanying drawings, wherein like reference numerals refer to like elements throughout. While the embodiments are described with detailed construction and elements to assist in a comprehensive understanding of the various applications and advantages of the embodiments, it should be apparent however that the embodiments can be carried out without those specifically detailed particulars. Also, well-known functions or constructions will not be described in detail so as to avoid obscuring the description with unnecessary detail. It should be also noted that in the drawings, the dimensions of the features are not intended to be to true scale and may be exaggerated for the sake of allowing greater understanding.

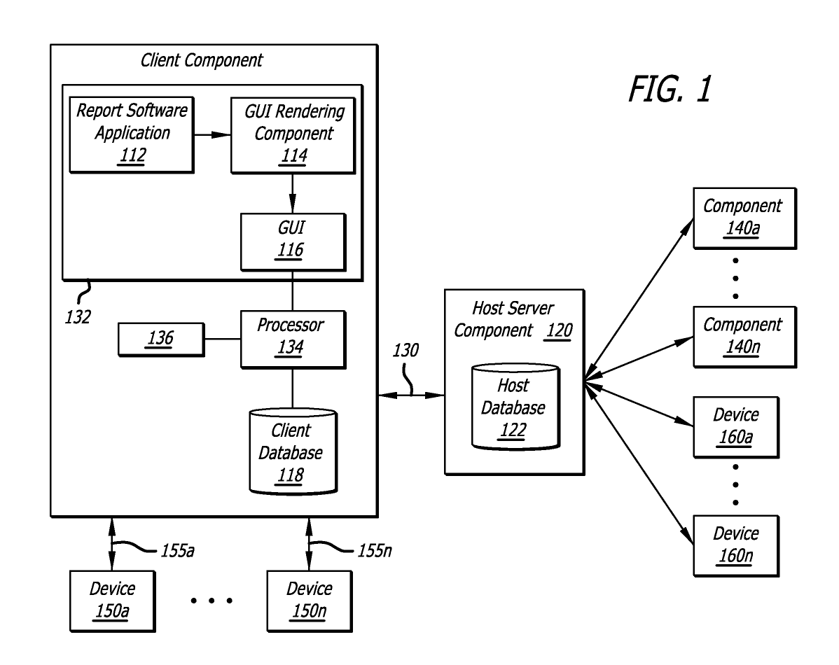

With reference to FIG. 1, a system 100 for generating integrated analyses and reports related to medical information and providing varying levels of information accessible to the user is illustrated. System 100 includes a client component 110 (e.g., on a computer, laptop, portable or handheld device that may be used by a patient) and, optionally, a host server component 120 (e.g., a computer, laptop, portable or handheld device that may be used by a clinician), wherein the components are coupled to one another through communication link 130. Report generation system 100 may further include one or more additional client components 140a-140n (e.g., for use by other patients) and/or medical devices 160a-160n (for use by the same or other patients) coupled to host server component 120 via communication links 145a-145n and 165a-165n, respectively.

The client component 110 may be embodied in a computing device, such as a user's personal computer, laptop, and/or handheld device. Further, the client component includes a memory 132 storing a report software application 112 and a GUI rendering component 114. The GUI rendering component 114 provides a GUI 116, that allows for user-interaction related to components displayed on the GUI 116 and for populating the GUI 116. In one embodiment, the GUI 116 is populated based upon information received from the host server component 120. Alternately, in another embodiment, the GUI 116 is populated based upon information received from a client database 118. Optionally, in an alternate embodiment, the GUI 116 is populated based upon information received from a medical device 150 connected to the client component. Further, in another optional embodiment, the GUI is populated based upon information received from any combination of information received from one or more of a medical device 150, client database 118 and the host component 122.

The GUI rendering component 114 may provide the GUI 116 with user-controllable features to allow the user to view, enter, upload, download, or otherwise manipulate and access data and information. Additional web-based application software and other client software may be stored in a memory 132 and may be executed by one or more processors 134 of client component 110.

As discussed above, the client component 110 further includes a client database 118. In one embodiment, the client database stores and organizes information provided on GUI 116. The client database may also store and organize information provided by host server component 120, if present. Additionally, in an optional embodiment, the client database 118 stores and organizes information received from one or more medical devices 150.

Client component 110 includes report software application 112, which receives and processes data input by a patient (for example, using a keyboard), uploaded from a medical device and/or as provided by host server component 120. Optionally, report software application 112 may receive data from a medical device 150 connected to a client component 110 and then process the received data.

Report software application 112 may be configured to create and update multiple and various types of reports and representations based upon the received and/or processed information, user preference, importance of information, and the like.

If present, host server component 120 may additionally include a host database 122 for storing information from the patient and for storing the processed information from report software application 112. Additionally, in an optional embodiment, host database 122 may be configured to store information from a healthcare provide (HC). Host database 122 may be configured to exchange information with the client component 110 as well as client database 118. Host database 122 may store all or a portion of the information contained in client database 118.

Various program and software applications, including web-based software applications, may be stored in memory and may be executed by one or more processors of host server component 120 for performing various other operations, such as, for example, providing software updates to client component 110.

Host server component 120 may be coupled to various other entities and/or components 140a-140n through communication links 145a-145n. For example, host server component 120 may be coupled to multiple other client components so as to oversee, process, and/or distribute information to the multiple other client components.

One or more medical devices 150a-150n receive, store and transfer medical data, such as patient-related diagnostic measurements, medicaments administered, and the like. Medical devices 150a-150n may further be configured to perform various calculations related to its intended functionality, such as, for example, calculate a necessary drug dosage (e.g., an insulin bolus) based upon measured and/or provided parameters. The medical devices 150a-150n may be connected to the client component 110 through communication links 155a-155n for uploading of medical data.

In one embodiment, the host server 120 is connected via a communication link to the plurality of medical devices 160a-160n. The medical devices 160a-160n may be connected to host server component 120 through communication links 165a-165n to provide additional medical information. The medical devices 150a-150n and the medical devices 160a-160n may include a various assortment of types of medical devices (e.g., glucose monitoring devices and insulin infusion pumps) and are not required to be related to the same type of functionality. Alternatively, according to another embodiment, each medical device 150a-150n and 160a-160n may be of the same type, such as all glucose monitoring devices.

Medical device 150 may be associated with a particular client component, such as the client component 110. In such a case, client database 118 may directly store medical data from medical device 150. In addition to the storage in client database 118, the medical data from medical device 150 may be sent to host server component 120 for processing and storage thereof.

Communication links 130, 145a-145n, 155a-155n, and 165a-165n may be any suitable communication protocol for transferring data, including one or more of an Ethernet connection, RF communication protocol, an infrared communication protocol, a Bluetooth enabled communication protocol, an 802.11x wireless communication protocol, an equivalent wireless communication protocol, or the like.

In an example operation of the integrated analysis and report generation system 100, according to one embodiment, data is obtained by and/or stored on medical device 150a-150n (hereinafter “medical data”). For ease of reference, operation of the invention will be described with respect to a single medical device 150 having a single link 155 to client component 110, but the invention will be understood not to be limited to such single device and link. Medical device 150 is connected to the client component 110 via communication link 155, whereupon the medical data is uploaded to and stored in client database 118. The transmission of medical data may be continuous, at predetermined time intervals, at predetermined times, or upon command by the patient or an external user.

In this example embodiment, the client component is embodied in a computing device having a processor 134 user input device (e.g., a keyboard) and a display 136. When the user of the client component 110 wants to access the medical data, then the report software application 112 processes the medical data to obtain, for example, different calculations and/or representations related to the medical data. The processing of the medical data may include various operations, such as, but not limited to, determining medicinal dosage, calculating various chemical and/or biological attributes related to the patient, such as glucose or blood-sugar levels, and preparing graphical or other representations of the medical data. According to an embodiment, the processing of the medical data may include organizing the medical data to display the medical data in a user-friendly manner. The particular type of processing provided may be determined based upon the patient, the type of medical device, or instructions provided by the patient or an external user, such as a clinician. The processed information may be stored in client database 118. Optionally, if utilized, the processed information may also be stored in host database 122. Different subsets of processed information may be stored by the two databases 118 and 120.

GUI rendering component 114 receives the medical data and the processed information and populates GUI 116 with the either or both sets of information (all “medical information”). The user is able to view the medical information through user-interaction on GUI 116 which is presented on the display 136 of the user's computing device. For example, multiple windows, boxes, icons, or other GUI components may be available for the user to formulate a desired request or obtain desired medical information. The user of client component 110 is able to save accessed medical information on client database 118 for later access thereto.

Optionally, in an alternate embodiment, the accessed medical information is not saved on the client database 118 and instead resides in the RAM of the connected medical device 150. Further, when the user is done accessing the data, the data is essentially deleted.

According to an embodiment, report generation system 100 may be used to implement a computer-based data management system known as the CoPilot® Health Management System (Copilot). Copilot® is a personal computer (PC or portable or handheld appliance)-based software application that permits people with diabetes, their healthcare team, and caregivers to upload data from FreeStyle® and Precision Xtra® blood glucose monitoring systems (and generally from several other commercially available blood glucose meters and insulin pumps) into the Copilot® application.

Copilot® provides an accessory to a blood glucose monitoring system such as the FreeStyle® and Precision Xtra® blood glucose monitoring systems and other commercially available blood glucose meters and insulin pumps. The Copilot® application provides graphs and other software tools for people with diabetes and their healthcare professionals/providers (HCPs) to evaluate and analyze medical information such as glucose readings, carbohydrate intake, insulin dosage, exercise and other diabetes-related factors uploaded from devices or manually entered into the system. The system can help identify trends that can be used to educate persons with diabetes to improve their glucose control, for example.

Additional detailed description of the above-described PC-based software application for healthcare management and its various features and functionality are provided in U.S. patent application Ser. No. 11/146,897 filed Jun. 6, 2005 entitled “Diabetes Care Report generation Architecture and Data Management System,” assigned to the Assignee of the present application and herein incorporated in its entirety.

When provided as a part of the CoPilot® application, report generation system 100 of the invention improves its functionality, as described hereinbelow.

After installing report generation system 100 on a computing device, such as a personal computer or other data processing terminal (alone or as part of a system such as the CoPilot® System), data can be uploaded or copied from a compatible medical device, typed in from a keyboard, or imported from a file. Report generation system 100 analyzes the entered data and displays it in simple, clear, concise reports. The reports are viewable on the computer screen or on the display of the data processing terminal. Optionally, the reports may be printed out (in black-and-white or color format). One can also automatically print one or more reports that are selected to be printed or displayed with data uploaded from a particular device. Additionally, printed reports may be configured to include information, such as annotations and/or analysis that may be optionally displayed on the computer screen or display report. For example, the printed report may be configured to include information not displayed on the computer screen to avoid reliance by the user of manipulation of the software application. Alternatively, the printed report may be configured to automatically include only information of higher priority, e.g., significant high or low blood glucose levels, when too much information is displayed in the report as represented on the computer screen or display.

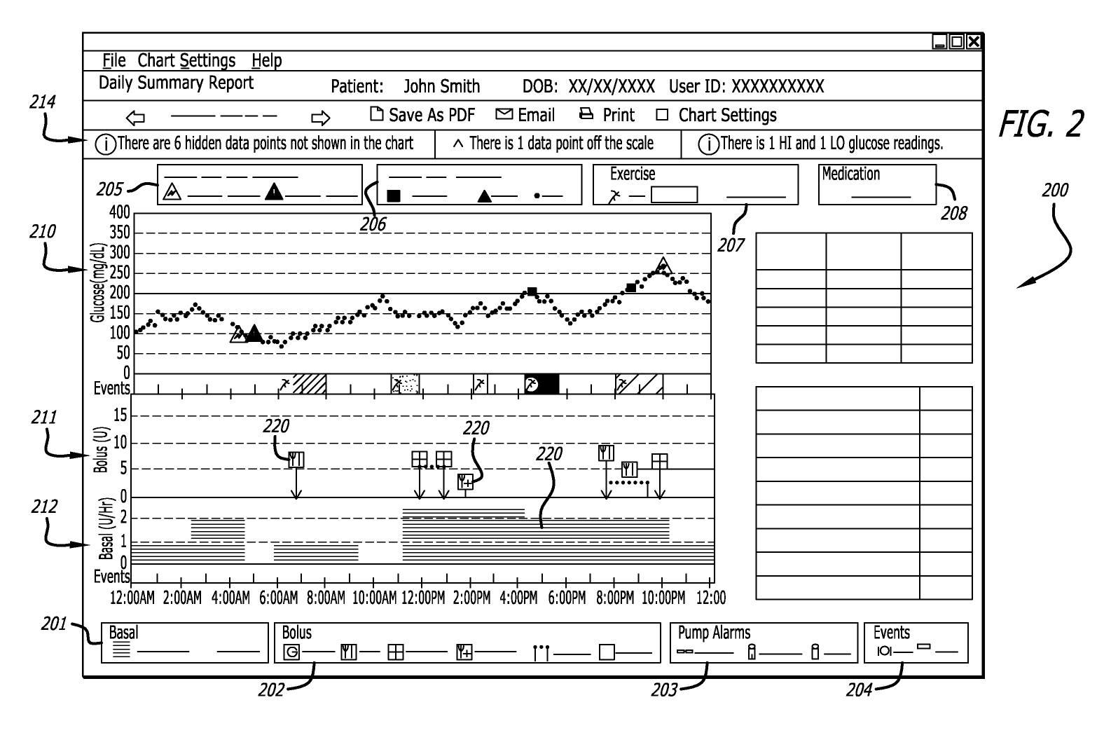

With reference to FIG. 2, a graphical user interface (GUI) 200 for use with the integrated analyzes and report generation system 100 is shown. In particular, FIG. 2 illustrates, the GUI presented to the user of the system 100.

GUI 200 includes various non-tabular visual information elements 220 that each provide medical information concerning a patient or other subject. The non-tabular visual information elements are generally any element or symbol on the GUI 200 that is not in a table. The GUI includes boxes 201-208 that include visual information elements 220. More particularly, boxes 201, 202, 203, and 204 are displayed near the bottom of GUI 200, and boxes 205, 206, 207, and 208 are displayed near the top of the GUI 200. The boxes 201-208 are intended to provide medical information. Visual information elements 220, in this embodiment, may be described as descriptive icons.

In this example, box 201 includes information pertaining to basal information and includes an icon for each of the following basal insulin types: programmed and temporary. Box 202 provides information pertaining to bolus information and in this example embodiment includes an icon for each of the following bolus insulin types: general, food, correction, food and correction, extended, and override. Box 203 provides information pertaining to pump alarm and includes an icon for various alarm states including occlusion, low insulin, and empty. Box 204 includes information pertaining to events and may include icons indicating events such as, but not limited to a food event and a prime event.

Box 205 provides information pertaining to glucose CGM alarm conditions, and may include icons indicating conditions such as projected glucose and high/low glucose conditions. Box 206 provides information pertaining to glucose reading sources and may include icons indicating such sources as self-reported, meter and sensor. Box 207 provides information pertaining to exercise intensity and may include icons representing such intensity states as: not reported, low, medium and high. Box 208 provides information related to medication and may include an icon associated with medication. Those skilled in the art will appreciate that visual information elements 220 are not limited to descriptive icons and other representations or elements may be utilized than those represented in the figures and described herein.

Graphs 210, 211, and 212, displayed near the center of GUI 200, respectively provide information related to glucose level, bolus units, and basal units. Visual information elements 220 defined in various boxes 201-208 are accordingly populated at various points of graphs 210, 211, and 212 when appropriate to indicate a relevant condition or event (i.e., medical information).

Those skilled in the art will appreciate that GUI 200 may include other boxes, charts, tables, indicators, and representations of patient or other information necessary or desired by a user.

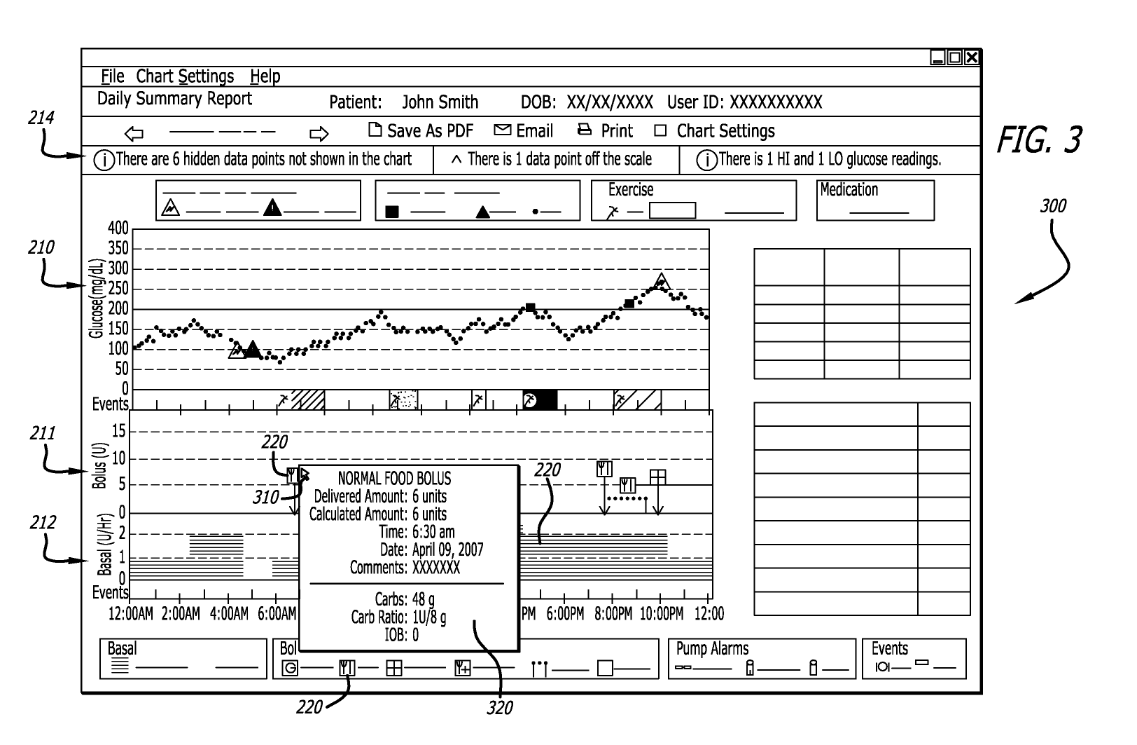

With reference to FIG. 3, a GUI 300 is illustrated. A cursor 310 is provided that functions to point to an image or other area of interest on GUI 300 of the display based upon user-interactions with, for example, a mouse or other external selection device. Once the cursor 310 is placed over the area of interest, such as over a non-tabular visual information element 220, then a further level of information is revealed to the user. More particularly, in FIG. 3, a pop-up or tool-tip window 320 is viewable to the user when the cursor 310 is placed over the visual information element 220. The window 320 provides additional medical information pertaining to a normal food bolus.

Also provided on GUI 300 are, as described above with reference to FIG. 2 and GUI 200, are various non-tabular visual information elements 220 that provide medical information concerning a subject. For example, the descriptive icons displayed on the bolus graph 211 provide information indicating the type of bolus event (i.e., medical information).

A further level of information pertaining to the medical information is provided on the GUI 300 when the cursor 310 hovers over an information element 220. The further level of information may be intended to provide more detailed facts, statistics, records or the like related to the medical information represented by a visual information element displayed on GUI 300. For example, as shown in FIG. 3, a tool-tip 320 is provided and is related to a corresponding information element 220 when cursor 310 hovers over the particular information element 220. Tool-tip 320 may be a type of a pop-up window that opens over the display in response to the hovering of cursor 310 over information element 220.

The further level of information may be provided as a textual, graphical or symbolic display in the pop-up window or tool-tip, for example. The further level of information is not limited to tool-tips or pop-up windows and those skilled in the art will appreciate that the further level of information may be embodied in various other forms and/or representations. Optionally, the further level of information may also be displayed in a message bar 214 as shown in FIG. 2 and FIG. 3. According to an embodiment, the further level of information may include, but is not limited to, medical facts such as basal insulin information, bolus insulin information, pump alarm information, food event information, glucose level information, or prime event information, educational information concerning management of the medical condition being treated, commercial messages, such as a reminder to order additional treatment or diagnostic supplies, such as test strips, which may include ordering information, such as a link to a purchase section of an electronic commerce website.

According to another embodiment, the further level of information may include a comparison between a target information value and an actual information value stored in the data storage memory or database, such as client database 118, host database 122, or a medical device memory. Additionally, educational information concerning potential causes, management or a physiological effect of any difference between the target information and actual information may be incorporated into or comprise the further level of information. For example, educational information may include instructional information to assists the user in understanding the functional and/or substantive relationship between different types of data. Educational information may also include instructions to allow optimized use of a particular medical device, e.g., glucose monitoring device or infusion pump, or software application, such as report generation system 100 or a computer-based data management system, (e.g., CoPilot®). For example, educational information may include tutorials arranged as embedded further levels of information.

Moreover, according to an embodiment, the further level of information may include data derived from an analyte measurement device, such as, for example, a glucose sensor or meter. According to another embodiment, the further level of information may include data derived from a drug delivery device, such as, for example, an insulin infusion pump. Optionally, the further level of information may include device derived data. Generally, device derived data includes data and/or information that pertains to user operations of a device and wherein the information is captured by the device. Examples of such data includes, but is not limited to, change of glucose target settings, change of insulin settings, insulin override, turning on and off certain device functions such as alarm and alerts, and alarm and message acknowledgment.

Additionally, the further level of information may include data that is manually entered or provided into a database, such as host database 122 or client database 118. For example, the further level of information may include results of analysis based on collected and/or generated data in addition to other further information.

For the particular example shown in FIG. 3, cursor 310 hovers over a visual information element 220 that corresponds to a “food” bolus ingested by a patient. In response to the hovering of cursor 310, tool-tip 320 is generated to provide additional, more detailed information related to the “food” bolus event. The information shown in tool-tip 320 may be generated by the report software application 112 based upon medical data provided to client component 110 and/or by host server component 120 and/or by a software program stored in client component 110; e.g., as a module within report software application 112 or as a separate program. For example, the GUI rendering component 114 may also populate GUI 300 with tool-tip 320 based upon commands and/or information received from report software application 112.

Each further level of information is not limited to include the same types of medical information represented by a visual information element or in a preceding further level of information displayed. For example, the further level of information may instead be derived from the particular medical information it relates to. This distinction is illustrated in FIGS. 3, 4, and 5.

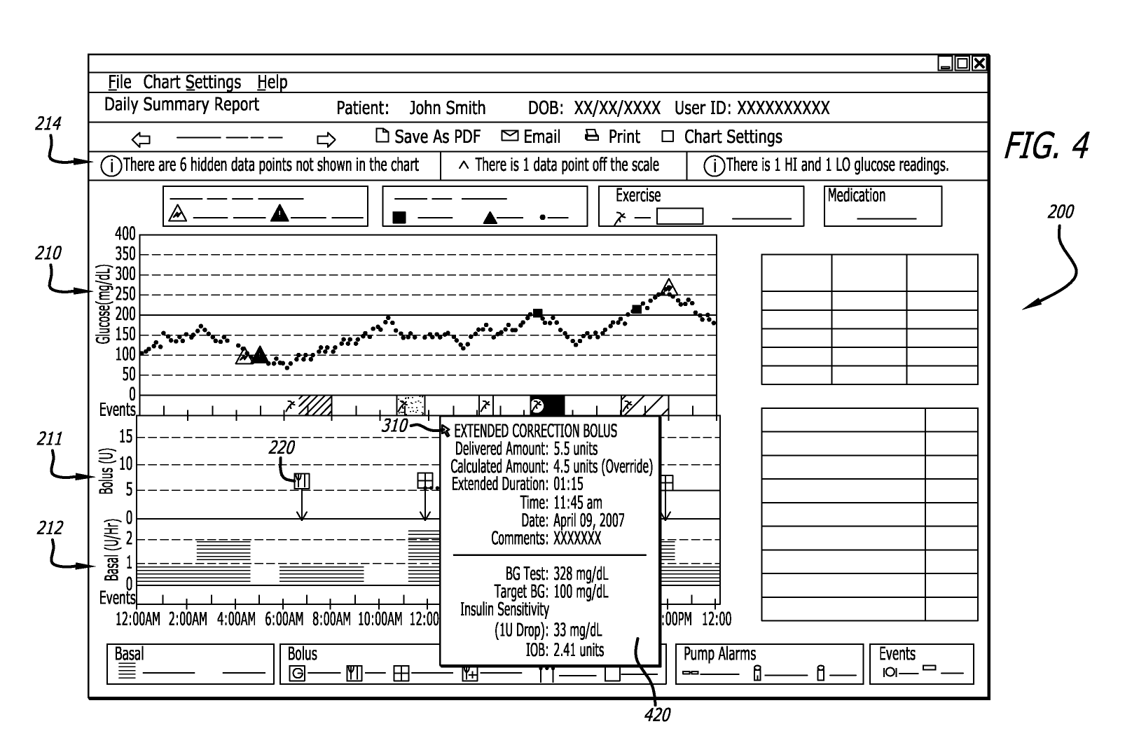

With reference to FIG. 4, a GUI 400 is illustrated with cursor 310 hovering over a visual information element 220 that corresponds to an “extended correction” bolus of insulin or food. In response to the hovering of cursor 310 over visual information element 220, a tool-tip 420 is generated to provide more detailed information related to the “extended correction” bolus event.

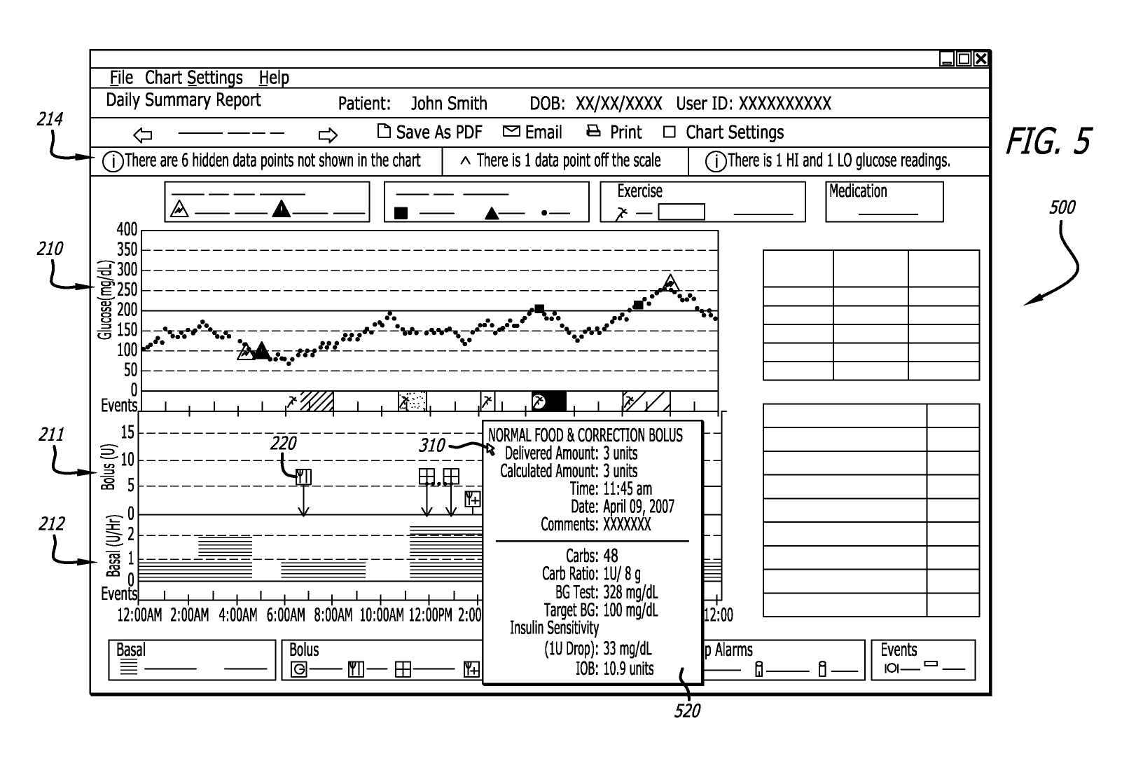

With reference to FIG. 5, a GUI 500 is illustrated with cursor 310 hovering over a visual information element 220 that corresponds to a “normal food and correction” bolus. In response to the hovering of cursor 310 over visual information element 220, tool-tip 520 is generated to provide detailed information related to the “normal food and correction” bolus event.

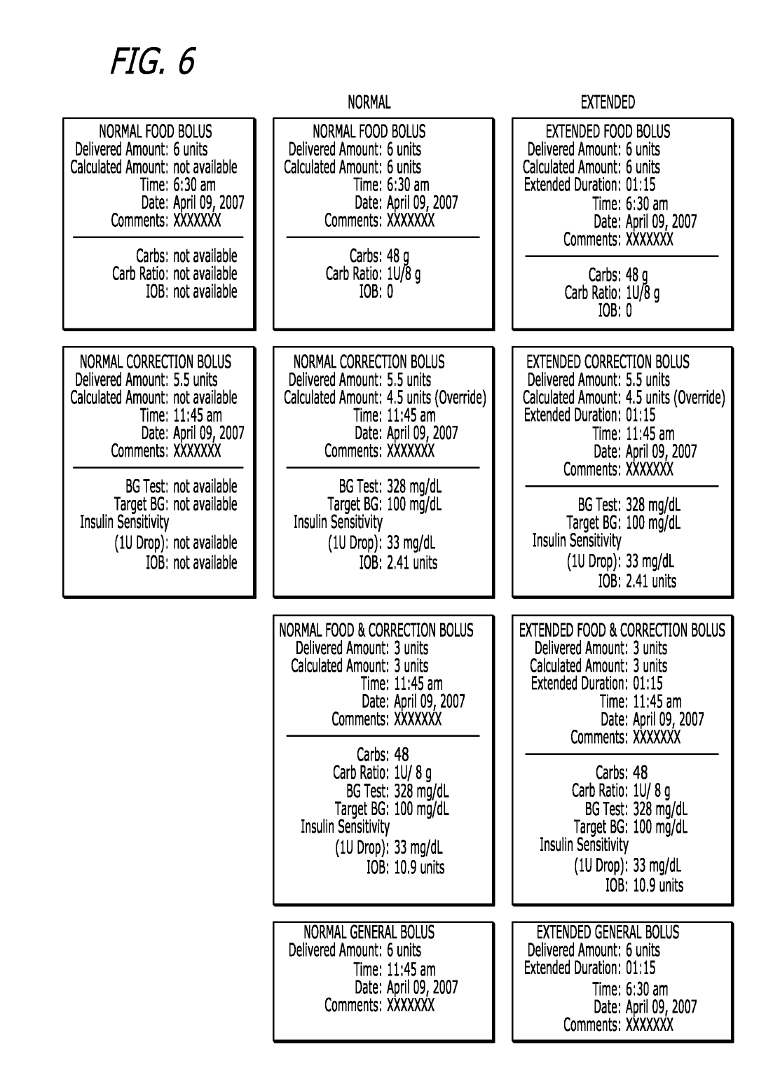

FIG. 6 provides examples of various additional tool-tips that may be provided. According to one example embodiment, multiple bolus insulin tool-tips, such as tool-tips 320, 420, and 520 respectively illustrated in FIGS. 3, 4, and 5, may be generated to correspond to multiple bolus insulin events that may be identified by visual information elements 220, as described above.

As discussed herein, data and information may be processed and visually represented in a GUI in a number of ways by report software application 112, by host server component 120, by a software program stored in client component 110, or by any combination thereof. The software program may be stored in client component 110 as a module within report software application 112 or as a separate program, either of which may be configured by the user, (e.g., patient or HCP). In various embodiments, determination of analysis and other report features (e.g., further information including annotations) to be visually represented in a GUI or as tool-tips and/or pop-ups are configured by the user, e.g., patient or HCP.

In another embodiment, the determination of the types of analysis to be performed may be achieved in various ways. The user may be provided with a selectable list of analyses from which the user may select or choose the desired analysis. Alternatively, a scripting mechanism may be provided.

As discussed further herein, sample analysis may involve event checks, such as events indicating compliance issues including general bolus, occlusion, low insulin alarms, and the like. Analysis may also involve threshold checks in which a metric is compared with a predetermined threshold. Also, analysis may involve event and response checks to determine whether user response is appropriate to an event. For example, intake of carbohydrates requires an associated bolus event which should be followed by glucose decrease within a certain time frame as opposed to glucose increase. Similarly, a low glucose alarm should be corrected within a certain time frame. Likewise, exercise events higher than a threshold intensity or longer than certain duration should be followed by a reduction in basal bolus administration and an increase in carbohydrate ratio. Further analysis involves evaluation of observed trends, e.g., analysis of the time profile of one or more metrics, such as average glucose level, daily carbohydrate intake or daily insulin dosage, to determine increase or decrease over time. Additionally, further analysis could compare processed data and trends to evidenced based disease management guidelines and criteria.

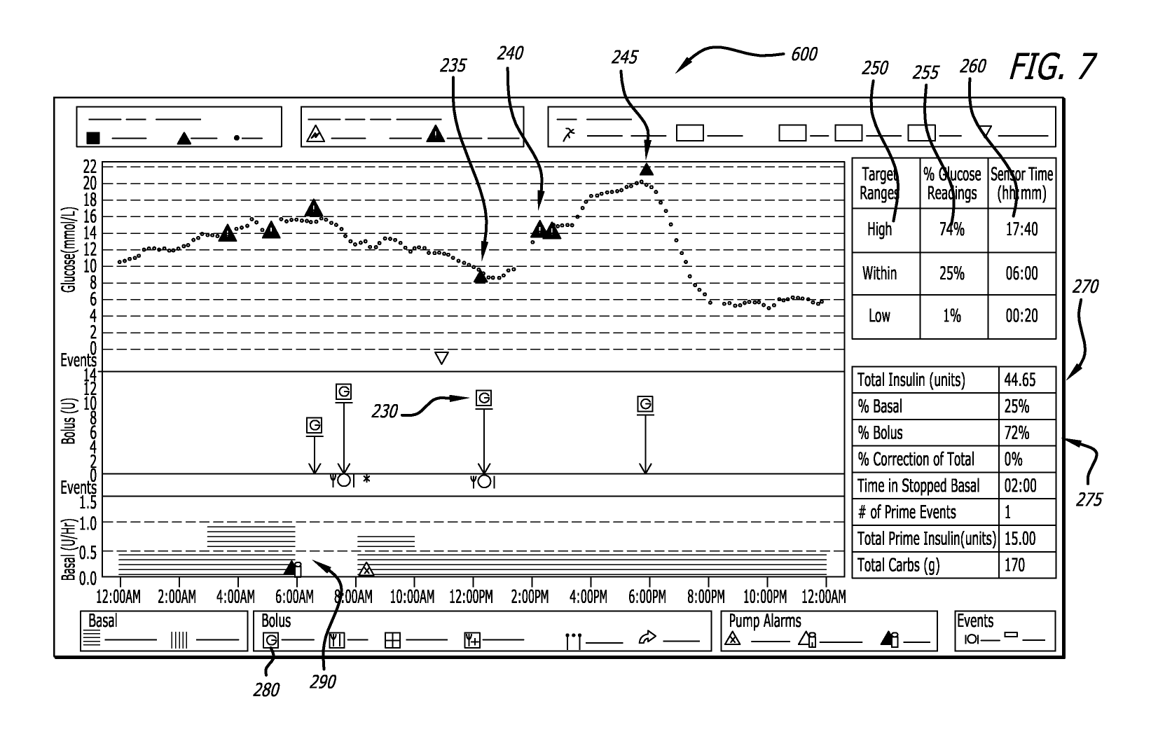

With reference to FIG. 7, a GUI 600 illustrates examples of various additional tooltips and/or pop-ups according to the invention. The skilled artisan would understand that information provided in a tool-tip may also be provided in a pop-up that may be configured to automatically display when a given set of criteria are met.

In regard to visual information elements 230, 235, 240 or 245, a tool-tip or pop-up may be generated to provide further, more detailed information related to insulin level, and educational information regarding management and suggested actions to be taken by the user. For example, visual information elements 230, 235, 240 and 245 are indicative of low insulin level, thus a tool-tip or pop-up is provided indicating such. The tool-tip or pop-up may also provide corrective actions such as instructing use of a bolus calculator to confirm the insulin level, checking for occlusions associated with the pump, and confirming pump alarm settings are correct and audible.

In regard to visual information elements 250, 255 or 260, a tool-tip or pop-up may be generated to provide further, more detailed information related to glucose level, and educational information regarding management and suggested actions to be taken by the user. For example, visual information elements 250, 255 or 260 indicate a high percentage of glucose readings as being in a higher than normal glucose range, thus a tool-tip is provided indicating such. The tool-tip or pop-up may also provide corrective actions such as instructing adjustment of the basal rate of insulin infusion, and using the bolus calculator when administering a bolus to avoid providing a larger bolus than required.

In regard to visual information elements 270 or 275, a tool-tip or pop-up may be generated to provide further, more detailed information related to insulin level and administration, and educational information regarding management and suggested actions to be taken by the user. For example, visual information elements 270 or 275 show a basal to bolus insulin ratio that is indicative of non-optimized pump usage, thus a tool-tip or pop-up is provided indicating such. The tool-tip or pop-up may also provide corrective actions such as instructing fine tuning of the basal rate, and use of a bolus calculator when preparing to administer insulin to ensure the correct dosage is administered.

In regard visual information element 280, a tool-tip or pop-up may be generated to provide further, more detailed information related to bolus amount and administration, and educational information regarding management and suggested actions to be taken by the user. For example, based on visual information elements represented in FIG. 7 indicating administration of excessive bolus amounts, a tool-tip or pop-up associated with visual information element 280 may be provided indicating a possible over-reaction or under-reaction by the user with regard to administration of appropriate bolus amounts. The tool-tip or pop-up may also provide corrective actions such as instructing use of a bolus calculator when bolusing to ensure the correct amount of insulin is administered.

In regard to visual information element 290, a tool-tip or pop-up may be generated to provide further, more detailed information related to basal administration, and educational information regarding management and suggested actions to be taken by the user. For example, based on visual information elements represented in FIG. 7 indicating a significant interruption in basal insulin infusion time, a tool-tip or pop-up associated with visual information element 290 may be provided to identify such interruption. The tool-tip or pop-up may also provide corrective actions such as instructing the user to ensure the low insulin alarm is appropriately set.

Those of ordinary skill in the art will recognize in view of this disclosure that tool-tips providing different or additional levels of information may also be provided which relate to the medical information represented by a visual information element and/or to a further level of information displayed. For example, if even more detailed information regarding a visual information element is desired, hovering of cursor 310 over the first tool-tip displayed may cause a further tool tip to be displayed with such additional information. Such additional information shown in the further tool-tip may be generated by report software application 112 based upon medical data provided to client component 110 and/or by host server component 120 and/or by a software program stored in client component 110; e.g., as a module within report software application 112 or as a separate program. Thus, for example, the GUI rendering component 114 may also provide the further tool-tip based upon commands and/or information received from report software application 112.

Also, in another embodiment, another level of information is provided that includes information pertaining to medical device information and/or medical device functions. Example of information provides includes extended bolus that includes a “duration” field and a “time” field to indicate a start time. Information that is not available may be identified as “not available.” If certain bolus calculator parameters are unavailable, for example, blood glucose (BG) target, sensitivity factor, and/or an insulin to carbohydrate ratio, then the corresponding value is identified as “not available.”

Also according to an embodiment, a “calculated amount” may be the requested amount, described by carbohydrate bolus plus correction bolus minus insulin on board (IOB), where carbohydrate bolus, correction bolus, and IOB have corresponding fields that may be identified in one of the tool-tips or other further level of information. A “delivered amount” may be the actual bolus insulin amount delivered to the patient. An “override” occurs, according to an embodiment, when the “calculated amount” does not equal the “delivered amount” to indicate that the patient terminated the bolus before the medical device (e.g., insulin pump) completed the bolus injection or that the patient modified the calculated amount in a bolus calculator, for example. The “override” event may be conveniently displayed to a clinician or other user on the GUI.

The GUI may also be provided with functionality, which may optionally be programmed to be enabled or disabled, by report generation software 112 allowing each further level of information to be retained in the display or superseded as another further level of information is accessed. For example, where a first further level of information is provided in a pop-up window, functionality in report generation software 112 may be enabled so that hovering a cursor over the pop-up window will simultaneously trigger both its closing and the display of the next further level of information. In this matter, the visual display remains uncluttered for the user.

While the disclosure has been particularly shown and described with reference to several embodiments thereof with particular details, it will be apparent to one of ordinary skill in the art that various changes may be made to these embodiments without departing from the principles and spirit of the invention, the scope of which is defined in the following claims.

Additionally, the system may include a configuration setting to turn on and off the annotations, message bar, tool-tips and pop-ups that are based on more complex analyses and comparisons, or that provide additional educational and corrective actions and recommendations. Additionally, in another embodiment, the system may be configured to set the levels of detail to display. More particularly, the system allows for configuration for viewable levels of information. Additionally, the system allows for configuration of priority levels. More particularly, the priority of different information, annotation, and messages may be assigned along with corresponding trigger criteria.

Further, in an optional embodiment, the system may provide a tutorial mode where the report software application 112 will automatically step through each educational message with the user in an automatic and guided fashion so the user is not required to interact with the GUI through the cursor.

What is claimed is:

1. A system for generating a report having varying integrated levels of medical information related to a health condition available to a user, the system comprising:
a host server component connected to and controlling access to a host database, wherein the host server component is accessible by multiple users, and wherein the host server component receives and stores medical information in the host database;
a client component configured to connect to the host server component via a communication link, the client component comprising a display, a communication port, an input device, a processor, and a memory, wherein a report software application is stored on the memory in combination with a GUI rendering component and is configured to generate a report, and wherein the processor is configured to access the memory, load and run the report software application under which the processor is programmed to:
in combination with the graphical interface rendering component, provide a GUI on the display;
populate the GUI based upon received and processed medical information from the host server component;
arrange the medical information in predetermined, inter-related levels such that the levels of information are accessible by the user on the GUI; and
provide a cursor for pointing to an area of interest in the display and provide a non-tabular visual information element disposed in the display, wherein the non-tabular visual information element represents a level of medical information, wherein a further level of information pertaining to one or more layers of medical information are viewable by a user when the cursor is pointed over an image on the display.

2. The system of claim 1, wherein the medical information on the display is represented by an icon.

3. The system of claim 1, wherein the further level of information is one of at least basal insulin information, bolus insulin information, pump alarm information, food event information, glucose level information, and prime event information.

4. The system of claim 1, wherein the further level of information is one of at least educational information relating to at least one of the management, treatment and effects of a health condition related to the medical information.

5. The system of claim 1, wherein the further level of information is a commercial message.

6. The system of claim 1, wherein at least one of the medical information and a further level of information comprises data derived from an analyte measurement device.

7. The system of claim 1, wherein at least one of the medical information and a further level of information comprises data derived from an insulin pump device.

8. The system of claim 1, wherein the further level of information includes a comparison between a target information value and an actual information value stored in one of the client database and host database.

9. The system of claim 8, further comprising educational information concerning at least one of potential causes, management and a physiological effect of any difference between the target information and actual information.

10. The system of claim 1, wherein the graphic user interface further comprises a pop-up window opened over the display in response to hovering of the cursor over an information element.

11. The system of claim 1, wherein the further level of information comprises encouraging messages.

12. The system of claim 1, wherein the further level of information comprises additional warning information based on a combination of events and trends.

13. The system of claim 1, wherein the further level of information comprises compliance data.

14. The system of claim 13, wherein the compliance data includes information pertaining to at least one of bolus data, occlusion data and low insulin alarm data.

15. The system of claim 1, wherein the client component is configured to print a report to an attached printer, and the printed report includes a further level of information.

16. A report generation system for managing medical information related to a health condition, the system comprising:
a host server component connected to and controlling access to a host database, wherein the host server component is accessible by multiple users and stores multiple patient data sets, wherein the multiple patient data sets include medical information received from respective users, and the host server component is configured to receive and transmit user data;
a client component configured to connect to the host server component via a communication link, the client component comprising a client database, a display, a processor, a memory and a report software application stored on the memory and configured to generate reports, wherein the processor is configured to access the memory, load and run the report software management program under which the processor is programmed to:
receive medical information from at least one of the client database and host database;
process the received medical information;
provide a GUI on the display that allows for user-interaction related to components displayed on the GUI;
populate the GUI based upon received medical information;
arrange the medical information in predetermined, inter-related levels such that the levels of information are accessible by the user on the GUI; and
provide a cursor for pointing to an area of interest in the display and provide a non-tabular visual information element disposed in the display, wherein the non-tabular visual information element represents a level of medical information, wherein a further level of information pertaining to one or more layers of medical information are simultaneously viewable by a user when the cursor is pointed over an image on the display.

17. The system of claim 16, wherein the processor of the client component is connected to and controls access to the client database, and wherein the processor is programmed to receive and process data from a medical device connected to the client component.

18. The system of claim 16, wherein the medical information on the display is represented by an icon.

19. The system of claim 16, wherein the further level of information is at least one of basal insulin information, bolus insulin information, pump alarm information, food event information, glucose level information, and prime event information.

20. The system of claim 16, wherein the further level of information is one of educational information relating to at least one of the management, treatment and effects of a health condition related to the medical information.

21. The system of claim 16, wherein the further level of information is a commercial message.

22. The system of claim 16, wherein at least one of the medical information and a further level of information comprise data derived from an analyte measurement device.

23. The system of claim 16, wherein at least one of the medical information and a further level of information comprise data derived from an insulin pump device.

24. The system of claim 16, wherein the further level of information includes a comparison between a target information value and an actual information value stored in one of the client database and host database.

25. The system of claim 24, further comprising educational information concerning at least one of potential causes, management and a physiological effect of any difference between the target information and actual information.

26. The system of claim 16, wherein the graphic user interface further comprises a pop-up window having a different level of medical information opened over the display in response to hovering of the cursor over an information element.

27. The system of claim 16, wherein the further level of information comprises encouraging messages.

28. The system of claim 16, wherein the further level of information comprises additional warning information based on a combination of events and trends.

29. The system of claim 16, wherein the further level of information comprises compliance data.

30. The system of claim 29, wherein the compliance data includes information pertaining to at least one of bolus data, occlusion data and low insulin alarm data.

31. The system of claim 16, wherein the client component is configured to print a report to an attached printer, and the printed report includes a further level of information.

32. A report generation system for managing medical information related to a health condition, the system comprising:
a client component comprising a display, a first communication port, an input device, a processor, and a memory, wherein a report software application is stored on the memory in combination with a GUI rendering component and is configured to generate a report,
a medical device connected to the client component via the first communication port, wherein the medical device is configured to transmit medical data to the client component;
and wherein the processor is configured to access the memory, load and run the report software application under which the processor is programmed to:
in combination with the GUI rendering component, provide a GUI on the display;
populate the GUI based upon received and processed medical information from the medical device;
arrange the medical information in predetermined, inter-related levels such that the levels of information are accessible by the user on the GUI; and
provide a cursor for pointing to an area of interest in the display and provide a non-tabular visual information element disposed in the display, wherein the non-tabular visual information element represents a level of medical information, wherein a further level of information pertaining to one or more layers of medical information are viewable by a user when the cursor is pointed over an image on the display.

33. The system of claim 32, further comprising a host server component, and the host server component connected to and controlling access to a host database, wherein the host server component is accessible by multiple users, and the host server component receives and stores medical information in the host database,
and wherein the client component further comprises a second communication port, the second communication port configured to connect the client component to host server component, and wherein the client component receives medical information from the host database via the host server.

34. The system of claim 33, wherein the processor populates the GUI based upon received and processed medical data from the host database.

35. The system of claim 32, wherein the client component further comprises a client database for storing received medical data, and wherein the processor populates the GUI based upon received and processed medical data from the client database.

36. The system of claim 32, wherein the medical information on the display is represented by an icon.

37. The system of claim 32, wherein the further level of information is at least one of basal insulin information, bolus insulin information, pump alarm information, food event information, glucose level information, and prime event information.

38. The system of claim 32, wherein the further level of information is one of educational information relating to at least one of the management, treatment and effects of a health condition related to the medical information.

39. The system of claim 32, wherein the further level of information is a commercial message.

40. The system of claim 32, wherein at least one of the medical information and a further level of information comprise data derived from an analyte measurement device.

41. The system of claim 32, wherein at least one of the medical information and a further level of information comprise data derived from an insulin pump device.

42. The system of claim 32, wherein the further level of information includes a comparison between a target information value and an actual information value stored in one of the client database and host database.

43. The system of claim 32, further comprising educational information concerning at least one of potential causes, management and a physiological effect of any difference between the target information and actual information.

44. The system of claim 32, wherein the graphic user interface further comprises a pop-up window having a different level of medical information opened over the display in response to hovering of the cursor over an information element.

45. The system of claim 32, wherein the further level of information comprises encouraging messages.

46. The system of claim 32, wherein the further level of information comprises additional warning information based on a combination of events and trends.

47. The system of claim 32, wherein the further level of information comprises compliance data.

48. The system of claim 47, wherein the compliance data includes information pertaining to at least one of bolus data, occlusion data and low insulin alarm data.

49. The system of claim 32, wherein the client component is configured to print a report to an attached printer, and the printed report includes a further level of information.
